(19) United States
(12) Patent Application Publication
(10) Pub. No.: US 2008/0212952 A1
(43) Pub. Date: Sep. 4, 2008

(54) Copy Protection for Video Content Contained in the VOB File Structure

(75) Inventors: Richard H. Selinfreund, Clinton, CT (US); Scott Gerger, Des Moines, IA (US)

Correspondence Address: KELLEY DRYE & WARREN LLP, 400 ALTLANTIC STREET , 13TH FLOOR, STAMFORD, CT, 06901, US

(73) Assignee: Verification Technologies, Inc., Essex, CT (US)

(21) Appl. No.: 12/036,505

(22) Filed: Feb. 25, 2008

Related U.S. Application Data
(63) Continuation of application No. 11/330,607, filed on Jan. 12, 2006.
(60) Provisional application No. 60/643,739, filed on Jan. 13, 2005.

(51) Int. Cl. H04N 5/00

(52) U.S. Cl. 386/126; 386/E05.064

(57) ABSTRACT

A digital video optical recording medium comprising an optical state change material in the VOB file structure.

### CROSS REFERENCE TO RELATED APPLICATIONS

This application is a Continuation Application of U.S. patent application Ser. No. 11/330,607, filed Jul. 27, 2006, a 35 U.S.C. §111(a) application claiming priority to Provisional Patent Application No. 60/643,739 filed pursuant to 35 U.S.C. §111(b), with a filing date of Jan. 13, 2005. The disclosure of each such application is hereby incorporated by reference in its entirety where appropriate for teachings of additional or alternative details, features, and/or technical background, and priority is asserted from each.

### BACKGROUND OF THE INVENTION

1. Field of the Invention

The present invention generally relates to methods for copy-protection and anti-shrink of digital recording medium. More particularly, one embodiment of the present invention relates to copy-protection methods for protecting against manipulation of the VOB files of a digital recording medium, such as an optical disc, which manipulation allows for the production of a non-copyprotected digital data streams. Another relates to anti-shrink methods for reducing illicit diversion of digital recording medium by requiring exposure of the digital recording medium to an activation source for conversion of one or more errors introduced into the VOB files to a valid or readable data state.

2. Description of the Related Art

DVD Video Object (VOB) is one of the core files found on a DVD-Video disc and contains the actual movie data. That is, the VOB structure contains the video files. The VOB file generally contains multiplexed video stream, audio streams and subtitle streams.

One conventional structure for a DVD is illustrated at FIG. 3. In such conventional structure, the logic and command sets for set top control is: VTS=Structure of the Video Title Set; VMG=Structure of the Video Manager; VOB=Structure of the Video Object Set. A DVD may comprise one or more VOBs, VOBs may be composed of cells C with an ID number assigned to the cells and a VOB ID number assigned as well with the ID number being assigned from the VOB with the smallest LSN. VOB typically can be copied in continuous or interleaved blocks (see DVD specification for Read only Disc/Part 2 File System Specifications Version 1.0. FIG. 2.3-1 Example of UDF Bridge Volume Structure).

Historically, copy programs have been able to remove the video content encrypted on the discs by removing the VOB files and re-arranging the VOB files to make a complete video movie. Any process that could make the removed VOB files incapable of being manipulated to produce a playable video would be a significant advance in DVD movie copy protection and can be useful in preventing shrinkage from a distribution stream.

### SUMMARY OF THE INVENTION

Many DVD set top players are not designed to navigate to re-read sectors during the playing of movie content, as such would cause, for example, the same scene of a movie to be played twice or a pause and delay during the FBI warning or a dark screen before or during a movie. Thus in such DVD set top players designed to play movies security algorithms designed to protect against illicit copying that employ the step of re-reading of a portion of the disc to determine changes of read of in the data at one or more locations on of the disc are problematic. In one embodiment of the present invention there is provided a security algorithm which protects the VOB file structure from being copied with perfect fidelity which may not require re-reading of a portion of the disc, that is, for example, that a particular scene be played twice, or for example, a dark delay be placed between or during scenes. In such embodiment, the algorithm is placed in whole or in part in the VOB file structure.

In one embodiment, conventional pit structures of a pit-land optical recording medium are modified in the VOB file at discrete places or loci in a manner to induce an error at such discrete locations. An optical state change material, such as an inorganic, organic, or hybrid inorganic-organic material, that can change optical state from at least a first optical state to a second optical state, is then selectively chosen and positioned with respect to the error such that an optical state change in the optical state-change material causes the error state to be read as either a valid state or decipherable ambiguous state or another invalid state, such as an error state, that may be correctable by correction algorithms associated with the system as opposed to the first error state. The optical state change material may be selected so as to be activated to change from the first optical state to the second optical state by energy provided by the reader of the digital recording medium, or may be selected to be activated by another activation source such as a electromagnetic wave generator, a heat source, sound source, etc.

In one embodiment having anti-shrink utility, a source other than the digital recording medium effectuates activation, and the optical state change is a non-reversible state change. In such embodiment the digital recording medium elicits errors in the VOB file structure when the optical state change material is unactivated, but once activated one or more of the errors are not detected by the reader of the digital medium. Thus, without appropriate activation of the recording medium, the medium read would be corrupt. Thus a reduction in shrinkage may be produced, as persons in the distribution chain inclined to pilfer the recording medium (or the data thereon) would be dissuaded from doing so knowing that without appropriate activation the medium would be unplayable, or if playable, of undesired quality.

The optical state change material of the present invention may, without limitation, be a one-way transition optical phase change material (that is moving from a first state to the second state upon activation and therein remaining in the second state without application of energy), or a transient or snap-back optical state change material (that is moving from the first state to the second state upon activation, and then without application of energy reverting to the first state after a period of time).

In one embodiment, one or more VOB file is first read as an error and after optical state change material activation, such as dye activation, the sector becomes a valid movie scene. This may be referred to as an “error-to-valid” data read change. In this case, for example, the unauthorized copy of the video could have one or more of its VOB files containing errors that are un-corrected with the movie full of errors in multiple scenes. By selective placement of optical state change material, one may change the errors after activation of the material. Only the discs with selectively placed optical state change material would have the scenes “corrected”.

In another embodiment, the copy protection method does employ re-read of the sector but does not require digital movie content to be played twice. In such method, an algorithm on the optical recording medium requires a repeated detection of the material in either/or of its activated or unactivated states for the VOB files to be read. In such embodiment, the optical state change material, such as dye, is placed such that a laser read in proximity to the material may activate the material without the need to directly read the exact location wherein the material is placed, or re-read it multiple times. This accomplishes a re-read of the sector twice without having to play the digital movie content twice.

Such copy-protection approaches may be applicable to any kind of optical data storage method without restriction to data formats, e.g. DVD-Video, DVD-ROM, DVD-Audio, non-DVD optical data storage formats. Pit geometry may be modified such that the combination of the optical state change material system, that is the optical state change material in conjunction with other materials used to stabilize, improve, alter, etc. its effects or application, and pit geometry allow for two or more data states to be possible at the locations. That is, the optical state change material system, such as dye system, and the specific pit geometry makes possible a complementary data state. By selectively choosing pit geometries in respect of the optical state change material system one can further provide valid-to-error and error-to-valid data state changes using existing user data. A form of pseudo-valid-to-valid data state change may also be implemented.

In an embodiment, errors may be introduced into user data by the playback laser as the optical state change system (e.g., dye system) changes giving a valid-to-error data state change. In another embodiment, errors may be cleared by the playback laser, giving an error-to-valid data state change. Embodiment methods herein may be designed not to consume any of the user data capacity of the disc for implementation of the security method.

### BRIEF DESCRIPTION OF THE FIGURES

The accompanying drawings, which are incorporated in and constitute part of the specification, illustrate illustrative embodiments of the invention, and together with the general description given above, and the detailed description of illustrative embodiments given below, serve to explain the principles of the invention.

FIG. 1 is side sectional view of a copyprotected disc having a pit associated with a quantum dye in a manner to permit activation of the quantum dye upon proximity read by a read laser;

FIG. 2 is graph of the proximity effect seen with respect to three optical state change material systems as set forth in Table 1; and

FIG. 3 (Prior Art) illustrates a conventional file structure of a video DVD.

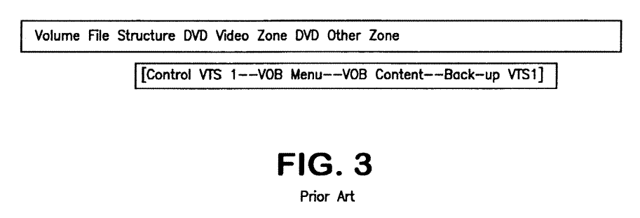

### DETAILED DESCRIPTION OF ILLUSTRATIVE EMBODIMENTS

### EXAMPLE 1

### Copy-Protected Optical Recording Medium Employing Modified Pits

A copy-protected optical recording medium of the DVD-type may be prepared in one embodiment of the invention by the following process:

Step 1: Prepare the authored disc image by implementing an authentication algorithm to test a particular target test file on the disc.

Step 2: Use a DVD image analyzer, e.g. “Eclipse Image Analysis,” to determine the exact range of logical sectors that comprise the target test file.

Step 3: Use an image encoder to transform the logical sectors into the pit sequences that will form the physical sectors on the disc.

Step 4: Use a security encoder to designate the pit sequences to be modified within the physical sectors.

One may designate as security pits, pits that are longer than normal or are inserted into the longer spaces between other pits.

In one embodiment, the interaction of the dye system and the modified pit structures are chosen to cause all or part of the designated pits to disappear. One could, for example, designate that all of the pits of a certain length will disappear when a dye bleaches, or a specific sequence of pits and lands will disappear, or all pits will become shorter by one clock cycle. As would be understood, the number of possible permutations of the disappearing pit sequences is vast.

In one embodiment the unactivated dye system in conjunction with the security pit causes a valid data read. Upon activation of the dye system by the appropriate activator (such as electromagnetic wave, heat, sound, etc.) the activated dye system changes as to eventuate in an error read, such as an uncorrected error read by the drive's data decoder. That is, transition from valid to error data state may be detectable. That is, the effect of any such disappearance may be the formation of uncorrectable errors in the drive's data decoder. In one aspect of such embodiment, software may be located on the medium or associated with the medium reader that is designed to correct the VOB files, or allow read of the VOB files, only upon detection of such error data at one or more security pit locations.

In another embodiment, extra pits would decode as errors until they are hidden, such as by bleaching of the dye system. For example, upon bleaching the errors would disappear from the drive's data detector. The effect of these disappearing pits would be to clear the errors and result in valid data, a so-called error-to-valid data state change.

If both of these concepts are implemented on the same disc, then the drive could be commanded to detect a valid-to-error data state change in one file or security sector, and to detect an error-to-valid data state change in a different file or security sector, thereby producing a pseudo valid-to-valid data state change.

Step 5: Use a pit profiler to describe the physical dimensions of the pits designated for modification.

A pit profiler is used to define the physical dimensions (width and depth) of the pits that are ordinarily detected and decoded into user data. The combination, for example, of sorption (absorption or adsorption) in the dye and destructive interference from the diffraction caused by the physical depth of the pits may be detectable in the data channel. The nominal pits, i.e. non-security pits, may have physical dimensions that accommodate the dye (or other optical state change material or system) coating without altering the user data no matter whether the dye is in its initial opaque state or its bleached transparent state. The physical dimensions of the security pits may be shallower and/or narrower than the nominal pits. The presence of the dye in its initial opaque state, in combination with the normal diffraction effect may, for example, cause the security pits to be detected as pits. When the dye is bleached, the security pits may be no longer detectable because the diffraction effect alone may be selected to be insufficient to be perceived as a pit. Alternatively, for example, the security pits could be much deeper than nominal pits. The diffraction effect in the presence of bleached dye may be constructive instead of destructive and thereby render the pits as undetectable.

Such modified pit designs may be placed, for example, directly into sectors. The sector sequence define the content or the chapters that are played in movies.

Step 6: Master the disc thereby replacing the original user data sectors with the modified sectors;

Step 7: Mold substrates, spin coat the dye system, metalize, bond, and finish the discs for testing.

Modification descriptions according to the invention may be implemented on the recording medium, for example, in the form of program scripts, replacement sectors, and pit profile definition files, components which represent proprietary information, the totality of which preferably needed to replicate the security system.

### EXAMPLE 2

### Proximity Activation

Test substrates were coated with 3 different chemical formulations. Each disc was inserted into a Pulstec tester and a target track, “track 0,” was allowed to be bleached by the playback laser. The lowest voltage level of the analog readback signal was measured after 30 seconds of exposure to the read laser. The measured value, which may be used as a measure of the propensity for authentication, was designated “dIbottom” for track 0 and represents 100%. As individual security pits are bleached, in such embodiment it was intended that they disappear, i.e. increase in reflectivity thereby appearing as lands instead of pits. As quickly as possible then, the tester was commanded to jump one track at a time and measurements of dIbottom for each successive track were recorded. Tracks −1, −2, −3, +1, +2, +3 were tested.

Table 1 shows the level of bleaching observed relative to the target track 0 for 3 tracks toward the inside of the disc (−1, −2, −3) and 3 tracks toward the outside of the disc (+1, +2, +3). 100% indicates the maximum bleaching observed on track 0, the target track. Any value greater than zero indicates opportunistic bleaching of tracks that were not intended to be played.

TABLE 1

| | | | Track Jump Forward | | | | Track Jump Reverse | | | |
|---|---|---|---|---|---|---|---|---|---|---|
| Disc # | Chem # | l Bottom | 0 | 1 | 2 | 3 | 0 | −1 | −2 | −3 |
| SE 5669 | 338 | 0.71 | 1.22 | 0.84 | 0.74 | 0.7 | 1.22 | 0.84 | 0.76 | 0.71 |
| SE 5669 | 338 | 0.51 | 100% | 25.5% | 5.9% | −2.0% | 100.0% | 25.5% | 9.8% | 0.0% |
| SE 5681 | 344 | 0.83 | 1.44 | 1.25 | 1.05 | 0.89 | 1.44 | 1.27 | 1.01 | 0.91 |
| SE 5681 | 344 | 0.61 | 100% | 68.9% | 36.1% | 9.8% | 100.0% | 72.1% | 29.5% | 13.1% |
| SE 5693 | 346 | 0.8 | 1.52 | 1.12 | 0.91 | 0.82 | 1.5 | 1.05 | 0.93 | 0.83 |
| SE 5693 | 346 | 0.72 | 100% | 44.4% | 15.3% | 2.8% | 97.2% | 34.7% | 18.1% | 4.2% |

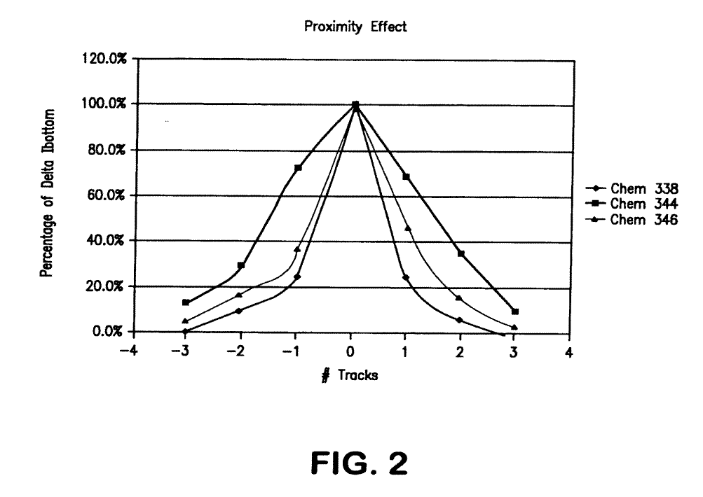

The results in the table may suggest that when the target track is bleached, the light from the playback laser beam's Gaussian profile exposes the neighboring tracks. The playback laser is able to substantially bleach the tracks immediately adjacent to the target. In the case of chemical formulation #344, 75% of the bleaching affect is realized on tracks +1 and −1. The so-called proximity effect shown in the table means that it may be possible to alter the data contained by tracks such as +1 and −1 without actually reading those tracks. Such proximity data is set forth in graphical form in FIG. 2 where percentage of Delta lbottom (y-axis) is set forth at different tracks (x-axis).

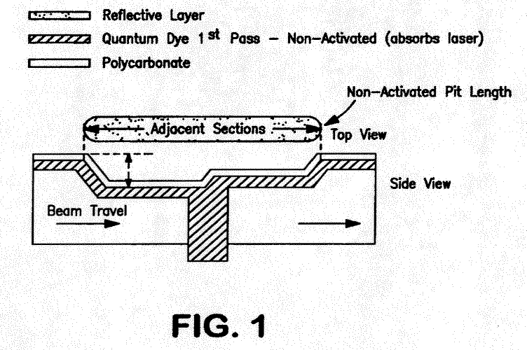

Now turning to FIG. 1, there is shown one illustrative embodiment of the invention wherein there is shown a disc in cut side view. Such figure illustrates how a laser reading in proximity to a optical state change security material (the quantum dye of the illustration) can activate the material without the need for the sector to be re-read twice or more (i.e., multiple times) so as to cause play of content twice.

### Statement Regarding Illustrative Embodiments

While the invention has been described with respect to certain illustrative embodiments, those skilled in the art will readily appreciate that various changes and/or modifications can be made to the invention without departing from the spirit or scope of the invention as defined by the appended claims. All documents cited herein are incorporated in their entirety herein.

1. A digital video optical recording medium having a VOB file comprising a plurality of pits and land structures, wherein one or more pits of the VOB file are modified structurally from the other pits of the VOB file and wherein said modified pits are associated with an optical state change material selected so as to be activated to change from a first optical state to a second optical state by exposure to energy generated by a source other than the optical reader.

2. The digital video optical recording medium, in accordance with claim 1, wherein the said source is an electromagnetic wave generator.

3. The digital video optical recording medium, in accordance with claim 1, wherein the said source is a source of thermal energy.

4. The digital video optical recording medium, in accordance with claim 1, wherein the said source is a source of acoustic energy.

5. The digital video optical recording medium of claim 1 wherein the modified pits comprise pits of different geometries from the majority of pits in the VOB file.

6. The digital video optical recording medium of claim 1 wherein the optical state change material is at least one selected from the group consisting of: a transient optical state change material, and a one-way optical state change material.

7. The digital video optical recording medium, in accordance with claim 1, wherein said first optical state of said optical state change material elicits data reading errors and said second optical state of said optical state change material permits valid data reading.

8. The digital video optical recording medium, in accordance with claim 1, wherein said second optical state of said optical state change material elicits data reading errors and said first optical state of said optical state change material permits valid data reading.

9. A method for activating an optical state change material utilized in a digital video optical recording medium having a VOB file comprising a plurality of pits and land structures, wherein one or more pits of the VOB file are modified structurally from the other pits of the VOB file and wherein said modified pits are associated with an optical state change material selected so as to be activated to change from a first optical state to a second optical state by exposure to energy generated by a source other than the optical reader, the method comprising the steps of:
placing said optical state change material in a configuration such that a laser read in proximity to said material may activate said material without the need to directly read the exact location where said material is placed; and
reading said VOB file with a read laser characterized by a beamwidth spanning the data track being read and the adjacent data track.
